(19) United States
(12) Patent Application Publication
(10) Pub. No.: US 2017/0286973 A1
(43) Pub. Date: Oct. 5, 2017

(54) Method and Device for Detecting Theft of Resources

(71) Applicants: Le Holdings (Beijing) Co., Ltd., Beijing (CN); LeCloud Computing Co., Ltd., Beijing (CN)

(72) Inventors: Mingyang Li, Beijing (CN); Hongfu Li, Beijing (CN)

(21) Appl. No.: 15/245,156

(22) Filed: Aug. 23, 2016

Related U.S. Application Data
(63) Continuation of application No. PCT/CN2016/089543, filed on Jul. 10, 2016.

(30) Foreign Application Priority Data
Mar. 31, 2016 (CN) 2016102016713

(51) Int. Cl. G06Q 30/00; G06Q 50/18

(52) U.S. Cl. CPC G06Q 30/0185; G06Q 50/184

(57) ABSTRACT

Embodiments of the present invention provide a method and an electronic device for detecting resource embezzlement. The method includes: acquiring a running record for resource embezzlement detection; and if the running record records a detection task interruption tag, reading information of a detection object that has been detected from the running record, acquiring information of all detection objects involved in the detection task, determining at least one to-be-detected object according to the information of the detection object that has been detected and the information of all the detection objects, and performing resource embezzlement detection on the at least one to-be-detected object. By adopting the embodiments of the present invention, an interrupted detection task may be continuously performed from a position where a previous detection stops, thereby preventing a detection object that has been previously detected from being repeatedly detected, increasing resource utilization rate, and improving detection efficiency.

### CROSS-REFERENCE TO RELATED APPLICATIONS

The disclosure is a continuation of PCT application No. PCT/CN2016/089543 submitted on Jul. 12, 2016, and is based upon and claims priority to Chinese Patent Application No. 2016102016713, entitled “METHOD AND APPARATUS FOR DETECTING RESOURCE EMBEZZLEMENT”, filed before Chinese Patent Office on Mar. 31, 2016, the entire contents of which are incorporated herein by reference.

### TECHNICAL FIELD

The present disclosure relates to the computer technologies, and more particularly, to a method for detecting resource embezzlement and an electronic device.

### BACKGROUND

With increasingly improvement of people's living standard, extremely high attentions are paid to copyrights of resources owned by individuals, for example, copyrights of videos, copyrights of audios, and copyrights of books. How to immediately detect and thus prevent a third party from violating the above described copyrights of individuals becomes a significant problem to solve.

A resource embezzlement detection mechanism detects to-be-detected data, to discover and prevent a third party from violating rights of individuals, for example, detecting a large number of to-be-detected objects to determine whether the large number of to-be-detected objects include designated information or a source thereof is a designated resource database. Specifically, for example, the resource embezzlement detection mechanism detects video resources provided by an disclosure, to determine whether the video resources include resources from a designated video website. During the detection process, the resource embezzlement detection mechanism sequentially detects a great amount of data therein according to a determined sequence of the to-be-detected objects.

However, if a fault occurs during the detection process and crashes the resource embezzlement detection mechanism, generally the to-be-detected objects are detected from the beginning according to the determined sequence when the resource embezzlement detection mechanism is executed again. As a result, at least one to-be-detected object that has been detected in a previous time needs to be detected again, thereby causing resource waste and reducing detection efficiency.

### SUMMARY

An objective of this disclosure lies in providing a method for detecting resource embezzlement and an electronic device for implementing the method, to continue an interrupted detection task from a position where a previous detection stops, thereby preventing a detection object that has been previously detected from being repeatedly detected, increasing resource utilization rate, and improving detection efficiency.

In a first aspect, embodiments of the present invention provide a method for detecting resource embezzlement. The method includes: acquiring a running record for resource embezzlement detection; and if the running record records a detection task interruption tag, reading information of a detection object that has been detected from the running record, acquiring information of all detection objects involved in the detection task, determining at least one to-be-detected object according to the information of the detection object that has been detected and the information of all the detection objects, and performing resource embezzlement detection on the at least one to-be-detected object.

In an embodiment, the running record further records an operation object, information of a simulation operation performed on the operation object, and a simulation operation sequence, where the operation object is an interactive item to be operated to acquire the information of all the detection objects; and the method further includes: sequentially performing a corresponding simulation operation on a corresponding operation object according to the operation object, the information of the simulation operation performed on the operation object, and the simulation operation sequence.

In an embodiment, the sequentially performing a corresponding simulation operation on a corresponding operation object according to the operation object, the information of the simulation operation performed on the operation object, and the simulation operation sequence includes: starting the tested application; and acquiring information of resources provided by the tested application as the information of all the detection objects.

In an embodiment, the acquiring information of resources provided by the tested application as the information of all the detection objects includes: capturing the information of the resources provided by the tested application, from a user interface that displays the information of the resources provided by the tested application, as the information of all the detection objects.

In an embodiment, the determining at least one to-be-detected object according to the information of the detection object that has been detected and the information of all the detection objects and performing resource embezzlement detection on the at least one to-be-detected object includes: simulatively clicking an interactive item for viewing or downloading a designated resource corresponding to information of any detection object other than the information of the detection object that has been detected, on the user interface, to enable the tested application to request the designated resource over a network; intercepting a response message, returned from the network, with respect to the request for the designated resource and extracting information of a download address of the designated resource from the response message; and if the information of the download address includes information of a predetermined content provider, recording information of the tested application and the designated resource.

In an embodiment, the method further includes: separately recording the operation object, the information of the simulation operation performed on the operation object, and the simulation operation sequence and separately recording at least one to-be-detected object that has been detected; and if no fault occurs in the detection task, deleting the operation object, the information of the simulation operation performed on the operation object, the simulation operation sequence, and information of the at least one to-be-detected object that has been detected.

In a second aspect, the embodiments of the present disclosure also provides an electronic device, including: at least one processor; and a memory for storing a program executable by the at least one processor, where execution of the instructions by the at least one processor causes the at least one processor to execute any foregoing method for detecting resource embezzlement of this disclosure.

In an embodiment, the apparatus further includes: an information recording module, configured to separately record the operation object, the information of the simulation operation performed on the operation object, and the simulation operation sequence and separately record at least one to-be-detected object that has been detected; and an information deleting module, configured to: if no fault occurs in the detection task, delete the operation object, the information of the simulation operation performed on the operation object, the simulation operation sequence, and information of the at least one to-be-detected object that has been detected.

According to the method for detecting resource embezzlement and the electronic device provided in the embodiments of the present invention, if an acquired running record for resource embezzlement detection includes a detection task interruption tag, information of a detection object that has been detected is read from the running record, and at least one to-be-detected object is determined according to the information of the detection object that has been detected and information of all detection objects, to further separately perform resource embezzlement detection on the at least one to-be-detected object, thereby preventing a detection object that has been previously detected from being repeatedly detected, increasing resource utilization rate, and improving detection efficiency.

### BRIEF DESCRIPTION OF THE DRAWINGS

One or more embodiments are exemplarily described by using figures that are corresponding thereto in the accompanying drawings; the exemplary descriptions do not form a limitation to the embodiments. Elements with same reference signs in the accompanying drawings are similar elements. Unless otherwise particularly stated, the figures in the accompanying drawings do not form a scale limitation.

FIG. 1 is a flowchart illustrating a method for detecting resource embezzlement according to Embodiment 1 of the present invention;

FIG. 2 is a flowchart illustrating a method for detecting resource embezzlement according to Embodiment 2 of the present invention;

FIG. 3 is a logic block diagram illustrating an apparatus for detecting resource embezzlement according to Embodiment 3 of the present invention;

FIG. 4 is a logic block diagram illustrating an apparatus for detecting resource embezzlement according to Embodiment 4 of the present invention;

FIG. 5 is another logic block diagram illustrating an apparatus for detecting resource embezzlement according to Embodiment 4 of the present invention; and

FIG. 6 is a schematic structural diagram illustrating hardware of a device for executing a method for detecting resource embezzlement provided in Embodiment 6 of the present invention.

### DETAILED DESCRIPTION

An inventive concept of some embodiments in this technical solution is: if an acquired running record for resource embezzlement detection includes a detection task interruption tag, information of the detection object that has been detected is acquired, and resource embezzlement detection is separately performed on a corresponding to-be-detected object according to the information of the detection object that has been detected and information of all detection objects, thereby preventing a detection object that has been previously detected from being repeatedly detected, increasing resource utilization rate, and improving detection efficiency.

The present invention is described in detail hereinafter in the exemplary embodiments with reference to the accompanying drawings.

### Embodiment 1

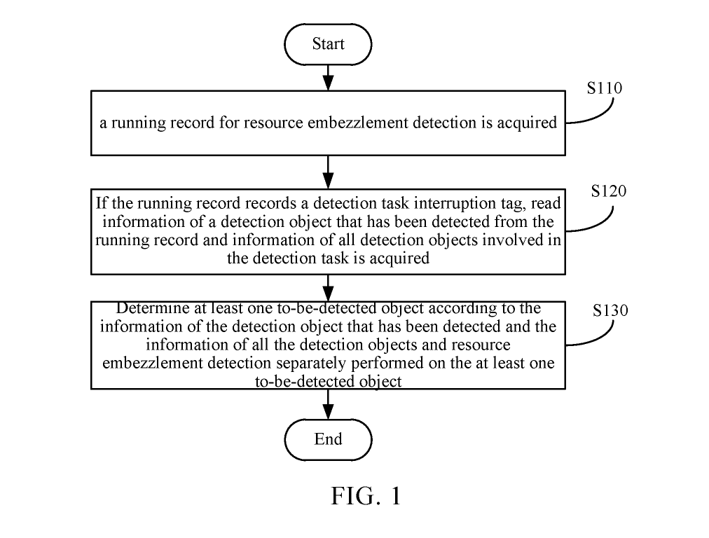

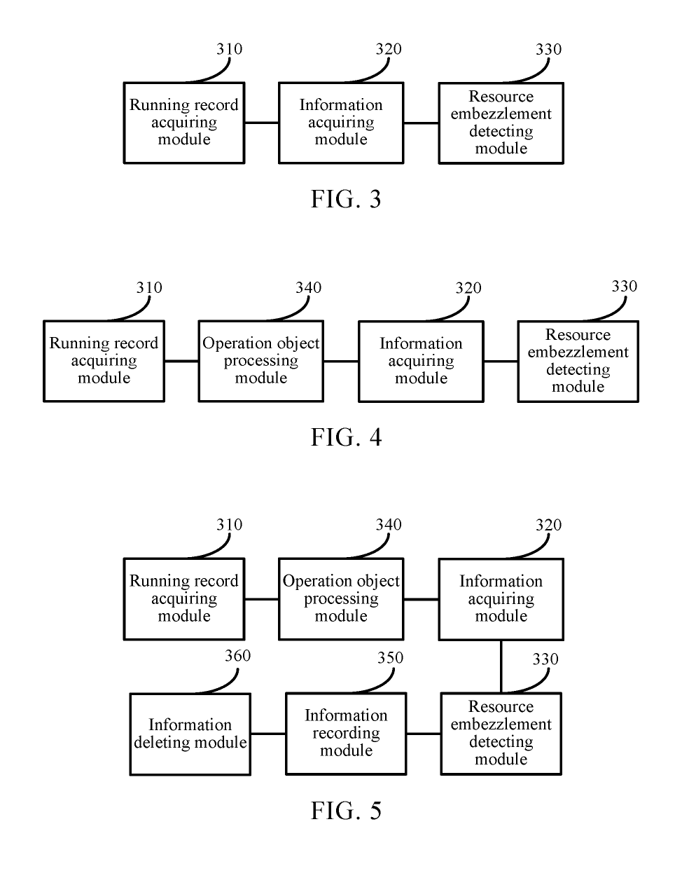

FIG. 1 is a flowchart illustrating a method for detecting resource embezzlement according to Embodiment 1 of the present invention, wherein a computer system incouding an apparatus as illustrated in FIG. 3 executes the method.

Referring to FIG. 1, in step S110, a running record for resource embezzlement detection is acquired.

The resource may include a video resource, an audio resource, a book resource and the like.

Specifically, detection of whether some resources are embezzled may be performed by using a resource embezzlement detection application. The resource embezzlement detection application may be programmed based on any operating system platform (for example, a Windows operating system platform, an Android operating system platform, a Mac OS operating system platform or an iOS operating system platform) and may be installed in a corresponding terminal device. A matched running record (which may also be referred to as an application running log) may be configured for the resource embezzlement detection application. Wach time resource embezzlement detection is performed on some resources by using the resource embezzlement detection application, relevant information during the detection process may be recorded in the running record. After the resource embezzlement detection application is restarted, the running record may be acquired.

In step S120, if the running record records a detection task interruption tag, information of a detection object that has been detected is read from the running record, and information of all detection objects involved in the detection task is acquired.

Specifically, if the resource embezzlement detection application crashes during the process of the resource embezzlement detection, the resource embezzlement detection application reads the running record after the resource embezzlement detection application is restarted, if a user needs to perform resource embezzlement detection on some resources detected during the previous crash. If the running record records a detection task interruption tag, information of a detection object that has been detected (for example, a name and/or an episode of the detection object) is acquired from the running record. Also, the resource embezzlement detection application acquires information of all detection objects involved in this detection task. For example, if a detection object is a video resource, information of all detection objects may be information of all video resources (for example, names and/or episodes of videos and the like), and the information of all the detection objects specifically may be names of all domestic movies and the like.

In step S130, at least one to-be-detected object is determined according to the information of the detection object that has been detected and the information of all the detection objects, and resource embezzlement detection is separately performed on the at least one to-be-detected object.

Specifically, the information of the detection object that has been detected may be removed from the information of all the detection objects, to obtain information of remaining detection objects. The information of the remaining detection objects may be analyzed, to determine a corresponding detection object as at least one to-be-detected object. Then, resource embezzlement detection is performed on the at least one to-be-detected object. Specifically, for any piece of information of any one remaining detection object, a corresponding to-be-detected object is acquired according to the information of any one remaining detection object. Meanwhile, a data packet in an interactive process of acquiring the corresponding to-be-detected object may be intercepted. Information indicative of a source of the at least one to-be-detected object is extracted from the data packet. Whether the information is consistent with information of a designated provider may be determined. If the information is consistent with the designated information of the provider, it is determined that the at least one to-be-detected object is obtained through embezzlement. If the information is not consistent with the designated information of the provider, the resource embezzlement detection is continuously performed on another to-be-detected object.

It should be noted that the present invention not only can be applied to a scenario in which a resource embezzlement detection application crashes, but also can be applied to scenarios in which a detection task is interrupted. If a user initiatively suspends the detection task, step S110 to step S130 may also be performed when the user needs to execute the detection task again by using the resource embezzlement detection application.

With the method for detecting resource embezzlement according to the embodiment of the present invention, if an acquired running record for resource embezzlement detection includes a detection task interruption tag, information of a detection object that has been detected is read from the running record, and at least one to-be-detected object is determined according to the information of the detection object that has been detected and information of all detection objects, to further separately perform resource embezzlement detection on the at least one to-be-detected object, thereby preventing a detection object that has been previously detected from being repeatedly detected, increasing resource utilization rate, and improving detection efficiency.

### Embodiment 2

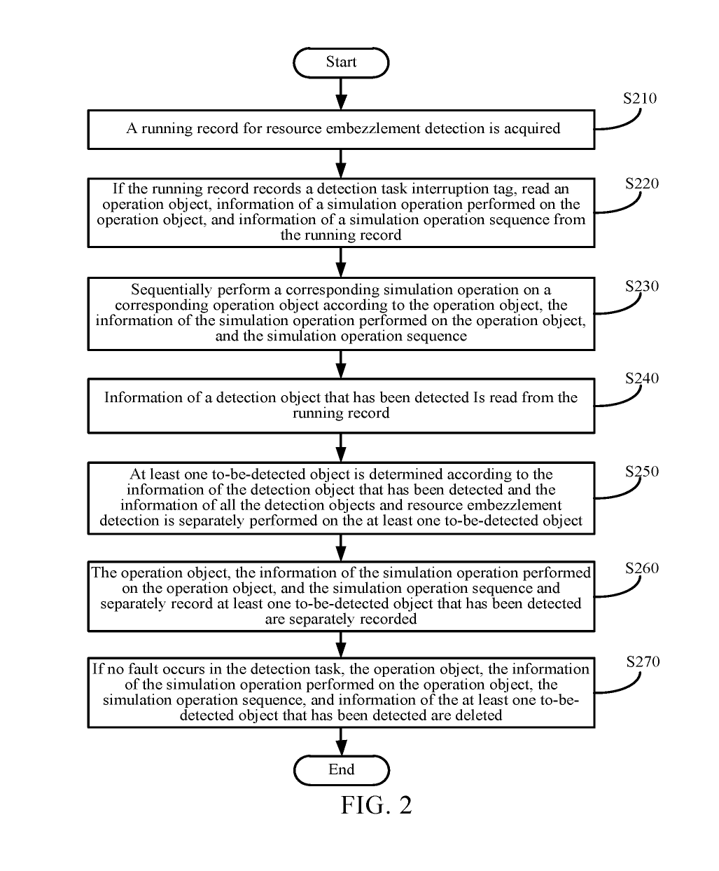

FIG. 2 is a flowchart illustrating a method for detecting resource embezzlement according to Embodiment 2 of the present invention. This embodiment may be considered as another implementation solution of FIG. 1.

Referring to FIG. 2, in step S210, a running record for resource embezzlement detection is acquired.

Content of step S210 is the same as that of step S110 in the above described Embodiment 1, which is thus not described herein any further.

The embodiment of the present invention may be practiced by using the resource embezzlement detection application. The resource embezzlement detection application may be configured to detect whether a resource provided by an application is a resource of a designated content provider, to thus determine whether the application embezzles the resource.

The resource embezzlement detection application may start an application through a simulation operation (for example, a simulative click or a simulative slide), and acquire information provided by the application. To this end, information relevant to each operation performed by the resource embezzlement detection application may be recorded. The information may include an operation object and a detection object. The operation object and the detection object may be marked. Which operations are operations that need to be performed and which operations are optional ones can be determined by marking. Generally, the operation corresponding to an operation object is an operation that needs to be performed and an operation corresponding to a detection object is an optional operation. For example, with respect to a resource embezzlement detection application, it is mandatory that a shortcut icon of the application is clicked simulatively to start an operation. Specific processing may be referred to step S220 to step S250 hereinafter.

In step S220, if the running record records a detection task interruption tag, an operation object, information of a simulation operation performed on the operation object, and information of a simulation operation sequence are read from the running record.

The operation object is an interactive item to be operated to acquire the information of all the detection objects, for example, a key, a shortcut icon or the like.

Specifically, if the running record records a detection task interruption tag, an operation object, information of a simulation operation performed on the operation object, and information of a simulation operation sequence, as well as information of the detection object that has been detected are read from the running record.

In step S230, a corresponding simulation operation is sequentially performed on a corresponding operation object according to the operation object, the information of the simulation operation performed on the operation object, and the simulation operation sequence.

Specifically, if it can be determined, according to the recorded operations that need to be performed and the optional operations, that an operation corresponding to the operation object is used as an operation that needs to be performed, a corresponding simulation operation is sequentially performed on the corresponding operation object according to the operation object, the information of the simulation operation performed on the operation object, and the simulation operation sequence.

For example, if a running record records the following content: simulatively clicking a shortcut icon of a tested application, starting the tested application, simulatively clicking a movie key on a homepage of tested application, simulatively clicking a domestic movie key on a movie page to display information of domestic movies, which may include information of a first movie, information of a second movie, and information of a third movie, simulatively clicking a key for playing or downloading the first movie, simulatively clicking a key for playing or downloading the second movie, and simulatively clicking a key for playing or downloading the third movie, that is, starting a tested application→simulatively clicking a movie key→simulatively clicking a domestic movie key→simulatively clicking information of a first movie→simulatively clicking information of a second movie→simulatively clicking information of a third movie. The tested application, the movie key, and the domestic movie key are operation objects. The information of the first movie, the information of the second movie, and the information of the third movie are detection objects. From the above described content, it can be determined that starting a tested application→simulatively clicking a movie key→simulatively clicking a domestic movie key are operations that need to be performed. Therefore, corresponding simulation operations are sequentially performed on the corresponding operation objects according to the sequence.

There may be various processing methods for step S230, and one operational processing method is provided below. The processing method may specifically include the following content:

Step 1: A tested application is started.

The tested application is an application installed in a television box, an application installed in a computer, an application installed in a mobile phone or the like.

Specifically, when the tested application needs to be detected, the tested application may be installed in a terminal device in which a resource embezzlement detection application is installed. After the installation is completed, relevant information of the tested application is provided to the resource embezzlement detection application. The resource embezzlement detection application identifies the tested application according to the relevant information. Then, the tested application may be started by a simulation operation, that is, the resource embezzlement detection application simulatively clicks a shortcut icon of the tested application. The tested application may acquire homepage information of the tested application from a cache or a server.

Step 2: Information of resources provided by the tested application is acquired as information of all detection objects.

Specifically, the resource embezzlement detection application may sequentially perform, according to information of resource classifications provided by the tested application, simulation operations on resource classification keys in the information, to obtain information of resources provided by the tested application as the information of all the detection objects. For instance, by using a video resource as an example, the tested application may provide information of resource classifications such as movies, television dramas, variety shows, and cartoons. The resource embezzlement detection application may simulatively click movies and domestic movies (a subclass under the movie classification). The tested application sequentially acquires movie page data and of domestic movie page data. The resource embezzlement detection application intercepts the domestic movie page data from the tested application, to obtain information of domestic movies, provided by the tested application, as the information of all the detection objects.

In addition to the above processing manner, the acquisition of the information of the resources provided by the tested application may also be implemented in other manners. An optional processing manner is provided as follows: capturing the information of the resources provided by the tested application, from a user interface that displays the information of the resources provided by the tested application, as the information of all the detection objects.

Specifically, based on the above described example, after the tested application sequentially acquires the movie page data and the domestic movie page data, the movie page data and the domestic movie page data may be sequentially displayed. The resource embezzlement detection application may capture, from the movie page data displayed on the user interface, information of all domestic movies as the information of all the detection objects.

In step S240, information of a detection object that has been detected is read from the running record.

It should be noted that step S240 may also be performed before step S220, or may also be performed concurrently with step S220.

In step S250, at least one to-be-detected object is determined according to the information of the detection object that has been detected and the information of all the detection objects, and resource embezzlement detection is separately performed on the at least one to-be-detected object.

Content of step S240 and step S250 is respectively the same as that of step S120 and step S130 in the above described Embodiment 1, which is thus not described herein any further

In addition, there may be various manners for performing resource embezzlement detection on the at least one to-be-detected object, and one optional processing manner is provided hereinafter. The processing manner may specifically include the following content:

Step 1: An interactive item for viewing or downloading a designated resource corresponding to information of any detection object other than the information of the detection object that has been detected, on the user interface is simulatively clicked, to enable the tested application to request the designated resource over a network.

The interactive item for viewing or downloading may be a key for viewing or downloading, or may also be a hyperlink for viewing or downloading and the like.

Specifically, the resource embezzlement detection application sequentially clicks, in a simulative click manner, keys for viewing or downloading resources corresponding to the information of resources provided by the tested application, to trigger the tested application to generate a viewing or downloading request. The tested application sends the viewing or downloading request to the server over the network, so that the server sends the designated resource to the tested application.

Step 2: A response message, returned from the network, with respect to the request for the designated resource is intercepted, and information of a download address of the designated resource is extracted from the response message.

Specifically, upon receiving the resource acquisition request, the server may analyze the resource acquisition request, identify the resource to be downloaded as the designated resource, meanwhile acquire a download address of the designated resource, and send a resource acquisition request to a resource server through the download address. The resource server may generate data of the designated resource and information such as the download address of the designated resource into a response message with respect to the request for the designated resource and send the response message to the server over a network. The server may send the response message to the tested application. At this time, the resource embezzlement detection application captures a data packet returned from the server to the tested application, to intercept the response message returned from the network, and to extract information of the download address of the designated resource from the response message.

Step 3: If the information of the download address includes information of a predetermined content provider, information of the tested application and the designated resource is recorded.

The content provider is an organization or individual that owns a copyright of some resources, for example, LeTV.

Specifically, information of one or more content providers may be set in advance, for example, information of the download address set by the content provider for the designated resource. The information of the download address may be compared with the information of the content provider. If the information of the download address includes information of the predetermined content provider, it is determined that the tested application embezzles the designated resource. For example, if the download address is http://aa.le.com/xx/kk and the information of the content provider includes aa.le.com, it can be determined that the tested application embezzles the designated resource. The resource embezzlement detection application may send the information of the tested application and the designated resource (for example, a name, a version number and the like of the tested application, and a name, an episode and/or a thumbnail and the like of the designated resource) to a resource embezzlement warning system, thereby preventing the tested application from acquiring the designated resource in time through the resource embezzlement warning system.

In addition, each time resource embezzlement detection is performed, the operation object, information of a simulation operation performed on the operation object, and a simulation operation sequence may be recorded, and information of at least one to-be-detected object that has been detected is separately recorded, specifically referring to the following step S260 and step S270.

In step S260, the operation object, the information of the simulation operation performed on the operation object, and the simulation operation sequence and separately record at least one to-be-detected object that has been detected are separately recorded.

In step S270, if no fault occurs in the detection task, the operation object, the information of the simulation operation performed on the operation object, the simulation operation sequence, and information of the at least one to-be-detected object that has been detected are deleted.

Specifically, to enable the resource embezzlement detection application to continue a previous detection task when being started again, if no fault occurs in the detection task, the operation object, the information of the simulation operation performed on the operation object, the simulation operation sequence, and the information of to-be-detected object that has been detected are deleted from the running record, or the detection task is marked as complete in the running record, therebey preventing the resource embezzlement detection application from continuing the previous detection task when being started again.

With the method for detecting resource embezzlement according to the embodiment of the present invention, in one aspect, a corresponding simulation operation is performed on a corresponding operation object separately, by acquiring an operation object, information of a simulation operation performed on the operation object, and a simulation operation sequence, and at least one to-be-detected object is determined according to information of a detection object that has been detected and information of all detection objects, to further perform resource embezzlement detection on the at least one to-be-detected object separately, thereby improving detection efficiency. In another aspect, by triggering a tested application to request a designated resource over a network to further intercept information of a download address and information of a predetermined content provider from a response message, returned from the network, with respect to the request for the designated resource, whether the tested application embezzles the designated resource is determined, to detect a resource embezzlement situation in time.

### Embodiment 3

Based on same technical concept, FIG. 3 is a logic block diagram illustrating an apparatus for detecting resource embezzlement according to Embodiment 3 of the present invention. Referring to FIG. 3, the apparatus includes a running record acquiring module 310, an information acquiring module 320 and a resource embezzlement detection module 330. The running record acquiring module 310 is connected to the information acquiring module 320. The information acquiring module 320 is connected to the resource embezzlement detection module 330.

The running record acquiring module 310 is configured to acquire a running record for resource embezzlement detection.

The information acquiring module 320 is configured to, if the running record records a detection task interruption tag, read information of a detection object that has been detected from the running record, and acquire information of all detection objects involved in the detection task.

The resource embezzlement detection module 330 is configured to determine at least one to-be-detected object according to the information of the detection object that has been detected and the information of all the detection objects, and separately perform resource embezzlement detection on the at least one to-be-detected object.

With the apparatus for detecting resource embezzlement according to the embodiment of the present invention, if an acquired running record for resource embezzlement detection includes a detection task interruption tag, information of a detection object that has been detected is read from the running record, and at least one to-be-detected object is determined according to the information of the detection object that has been detected and information of all detection objects, to further separately perform resource embezzlement detection on the at least one to-be-detected object, thereby preventing a detection object that has been previously detected from being repeatedly detected, increasing resource utilization rate, and improving detection efficiency.

### Embodiment 4

On the basis of the same technical concept, FIG. 4 is a logic block diagram illustrating an apparatus for detecting resource embezzlement according to Embodiment 4 of the present invention. Referring to FIG. 4, in addition to the running record acquiring module 310, the information acquiring module 320 and the resource embezzlement detection module 330 in FIG. 3, the apparatus further includes an operation object processing module 340. The running record acquiring module 310 is connected to the operation object processing module 340. The operation object processing module 340 is connected to the information acquiring module 320. The information acquiring module 320 is connected to the resource embezzlement detection module 330.

The running record further records an operation object, information of a simulation operation performed on the operation object, and a simulation operation sequence. The operation object is an interactive item to be operated to acquire the information of all the detection objects. The apparatus further includes: an operation object processing module 340, configured to sequentially perform a corresponding simulation operation on a corresponding operation object according to the operation object, the information of the simulation operation performed on the operation object, and the simulation operation sequence.

In addition, the operation object processing module 340 is configured to: start a tested application; and acquire information of resources provided by the tested application as the information of all the detection objects.

In addition, the operation object processing module 340 is configured to: capture the information of the resources provided by the tested application, from a user interface that displays the information of the resources provided by the tested application, as the information of all the detection objects.

In addition, the resource embezzlement detection module 330 includes: a simulation operation unit, configured to simulatively click an interactive item for viewing or downloading a designated resource corresponding to information of any detection object other than the information of the detection object that has been detected, on the user interface, to enable the tested application to request the designated resource over a network; an information intercepting unit, configured to: intercept a response message, returned from the network, with respect to the request for the designated resource and extract information of a download address of the designated resource from the response message; and an information recording unit, configured to, if the information of the download address includes information of a predetermined content provider, record information of the tested application and the designated resource.

Further, based on the embodiment as illustrated in FIG. 4, the apparatus as illustrated in FIG. 5 further includes: an information recording module 350, configured to separately record the operation object, the information of the simulation operation performed on the operation object, and the simulation operation sequence and separately record at least one to-be-detected object that has been detected; and an information deleting module 360, configured to: if no fault occurs in the detection task, delete the operation object, the information of the simulation operation performed on the operation object, the simulation operation sequence, and information of the at least one to-be-detected object that has been detected.

In the embodiments of the present invention, in one aspect, a corresponding simulation operation is performed on a corresponding operation object separately, by acquiring an operation object, information of a simulation operation performed on the operation object, and a simulation operation sequence, and at least one to-be-detected object is determined according to information of a detection object that has been detected and information of all detection objects, to further perform resource embezzlement detection on the at least one to-be-detected object separately, thereby improving detection efficiency. In another aspect, by triggering a tested application to request a designated resource over a network to further intercept information of a download address and information of a predetermined content provider from a response message, returned from the network, with respect to the request for the designated resource, whether the tested application embezzles the designated resource is determined, to discover a resource embezzlement situation in time.

Embodiment 5 of this disclosure provides a non-volatile computer storage medium, which stores computer executable instructions, where the computer executable instructions can execute the method for detecting resource embezzlement in any one of the foregoing method embodiments.

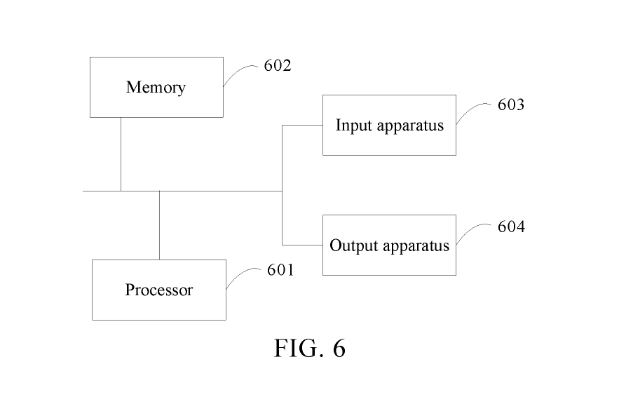

FIG. 6 is a schematic structural diagram illustrating hardware of a device for executing a method for detecting resource embezzlement provided in Embodiment 6 of the present invention.

one or more processors 601 and a memory 602, where only one processor 601 is used as an example in FIG. 6.

A server for executing the method for detecting resource embezzlement may further include: an input apparatus 603 and an output apparatus 604.

The processor 601, the memory 602, the input apparatus 603, and the output apparatus 604 can be connected by means of a bus or in other manners. A connection by means of a bus is used as an example in FIG. 6.

As a non-volatile computer readable storage medium, the memory 602 can be used to store non-volatile software programs, non-volatile computer executable programs and modules, for example, program instructions/module corresponding to the method for detecting resource embezzlement in the embodiments of this disclosure (for example, the running record acquiring module 310, the information acquiring module 320, and the resource embezzlement detection module 330 shown in FIG. 3). The processor 601 executes various functional applications and data processing of the server, that is, implements the method for detecting resource embezzlement of the foregoing method embodiments, by running the non-volatile software programs, instructions, and modules that are stored in the memory 602.

The memory 602 may include a program storage area and a data storage area, where the program storage area may store an operating system and an application that is needed by at least one function; the data storage area may store data created according to use of the apparatus for detecting resource embezzlement, and the like. In addition, the memory 602 may include a high-speed random access memory, or may also include a non-volatile memory such as at least one disk storage device, flash storage device, or another non-volatile solid-state storage device. In some embodiments, the memory 602 optionally includes memories that are remotely disposed with respect to the processor 601, and the remote memories may be connected, via a network, to the apparatus for detecting resource embezzlement. Examples of the foregoing network include but are not limited to:

the Internet, an intranet, a local area network, a mobile communications network, or a combination thereof.

The input apparatus 603 can receive entered digits or character information, and generate key signal inputs relevant to user setting and functional control of the apparatus for detecting resource embezzlement. The output apparatus 604 may include a display device, for example, a display screen.

The one or more modules are stored in the memory 602; when the one or more modules are executed by the one or more processors 601, the method for detecting resource embezzlement in any one of the foregoing method embodiments is executed.

The foregoing product can execute the method provided in the embodiments of this disclosure, and has corresponding functional modules for executing the method and beneficial effects. Refer to the method provided in the embodiments of this disclosure for technical details that are not described in detail in this embodiment.

The electronic device in this embodiment of this disclosure exists in multiple forms, including but not limited to:

(1) A mobile communication device which is capable of performing mobile communication function and having a main purpose for audio or data communication. Such a mobile communication device includes: a smart phone (e.g. iPhone), a multimedia phone, a functional mobile phone and a low-end mobile phone etc.

(2) A super-mobile personal computer which belongs to the field of a personal computer and has calculation and processing functions, and in general can access to a mobile network. Such a terminal device includes: a PDA, a MID and a UMPC etc., for example iPad.

(3) A portable entertainment device which is capable of displaying and playing multimedia content. Such a device includes: an audio player, a video player (e.g. iPod), a handheld game console, an electronic book, a smart toy and a portable automotive navigation device.

(4) A server which can provide calculation service and can include a processor, a hard disk, a memory, a system bus etc. Such a server is similar to a general computer in terms of a computer structure, but is necessary to provide reliable service, which therefore requires a higher standard in certain aspects such as data processing, stability, reliability, security and compatibility and manageability etc.

(5) Other electronic apparatus that is capable of data exchange.

The apparatus embodiment described above is merely exemplary, and units described as separated components may be or may not be physically separated; components presented as units may be or may not be physical units, that is, the components may be located in a same place, or may be also distributed on multiple network units. Some or all modules therein may be selected according to an actual requirement to achieve the objective of the solution of this embodiment.

According to the above description, the skilled person in this field can understand that various embodiments can be implemented by software over a general hardware platform or by hardware. Accordingly, the above technical solution or what is contributed to the prior art may be implemented in the form of software product. The computer software product may be stored in a computer-readable storage medium, for example random access memory (RAM), read only memory (ROM), compact disk (CD), digital versatile disk (DVD) etc. which includes instructions for causing a computing device (e.g. a personal computer, a server or a network device etc.) to perform a method of some or all parts of any one of the above described embodiments.

Finally, it should be noted that the previous embodiments are provided to enable any person skilled in the art to practice the various embodiments of the present disclosure described herein but not to limit these aspects. Though the present disclosure is described by reference to the previous embodiments, various modifications and equivalent features will be readily apparent to those skilled in the art without departing from the spirit and scope of the present disclosure, and the generic principles defined herein may be applied to other aspects or with equivalent features. Thus, the claims are not intended to be limited to the aspects and features shown herein, but are to be accorded the full scope consistent with the language of the claims.

What is claimed is:

1. A method for detecting resource embezzlement, applied to a terminal, comprising:
acquiring a running record for resource embezzlement detection; and
if the running record records a detection task interruption tag, reading information of a detection object that has been detected from the running record, acquiring information of all detection objects involved in the detection task, determining at least one to-be-detected object according to the information of the detection object that has been detected and the information of all the detection objects, and separately performing resource embezzlement detection on the at least one to-be-detected object.

2. The method according to claim 1, wherein the running record further records an operation object, information of a simulation operation performed on the operation object, and a simulation operation sequence, wherein the operation object is an interactive item that needs to be operated to acquire the information of all the detection objects; and
the method further comprises:
sequentially performing a corresponding simulation operation on a corresponding operation object according to the operation object, the information of the simulation operation performed on the operation object, and the simulation operation sequence.

3. The method according to claim 2, wherein the sequentially performing a corresponding simulation operation on a corresponding operation object according to the operation object, the information of the simulation operation performed on the operation object, and the simulation operation sequence comprises:
starting a tested application; and
acquiring information of resources provided by the tested application as the information of all the detection objects.

4. The method according to claim 3, wherein the acquiring information of resources provided by the tested application as the information of all the detection objects comprises:
capturing the information of the resources provided by the tested application, from a user interface that displays the information of the resources provided by the tested application, as the information of all the detection objects.

5. The method according to any one of claims 1 to 4, wherein the determining at least one to-be-detected object according to the information of the detection object that has been detected and the information of all the detection objects and separately performing resource embezzlement detection on the at least one to-be-detected object comprises:
simulatively clicking an interactive item for viewing or downloading a designated resource corresponding to information of any detection object other than the information of the detection object that has been detected, on the user interface, to enable the tested application to request the designated resource over a network;
intercepting a response message, returned from the network, with respect to the request for the designated resource, and extracting information of a download address of the designated resource from the response message; and
if the information of the download address comprises information of a predetermined content provider, recording information of the tested application and the designated resource.

6. The method according to any one of claims 2 to 4, further comprising:
separately recording the operation object, the information of the simulation operation performed on the operation object, and the simulation operation sequence, and separately recording at least one to-be-detected object that has been detected; and
if no fault occurs in the detection task, deleting the operation object, the information of the simulation operation performed on the operation object, the simulation operation sequence, and information of the at least one to-be-detected object that has been detected.

7. A non-volatile computer storage medium, which stores computer executable instructions that, when executed by an electronic device, cause the electronic device to:
acquire a running record for resource embezzlement detection; and
if the running record records a detection task interruption tag, read information of a detection object that has been detected from the running record, acquire information of all detection objects involved in the detection task, determine a at least one to-be-detected object according to the information of the detection object that has been detected and the information of all the detection objects, and separately perform resource embezzlement detection on the at least one to-be-detected object.

8. An electronic device, comprising:
at least one processor; and
a memory communicably connected with the at least one processor;
wherein instructions stored in the memory executable by the at least one processor, the instructions is executed by the at least one processor causes the at least one processor to:
acquire a running record for resource embezzlement detection; and
if the running record records a detection task interruption tag, read information of a detection object that has been detected from the running record, acquire information of all detection objects involved in the detection task, determine a at least one to-be-detected object according to the information of the detection object that has been detected and the information of all the detection objects, and separately perform resource embezzlement detection on the at least one to-be-detected object.

9. The non-volatile computer storage medium according to claim 7, wherein the running record further records an operation object, information of a simulation operation performed on the operation object, and a simulation operation sequence, wherein the operation object is an interactive item that needs to be operated to acquire the information of all the detection objects; and
the computer executable instructions is further used for:
sequentially performing a corresponding simulation operation on a corresponding operation object according to the operation object, the information of the simulation operation performed on the operation object, and the simulation operation sequence.

10. The non-volatile computer storage medium according to claim 9, wherein in the sequentially performing a corresponding simulation operation on a corresponding operation object according to the operation object, the information of the simulation operation performed on the operation object, and the simulation operation sequence, the electronic device is caused to:
start a tested application; and
acquire information of resources provided by the tested application as the information of all the detection objects.

11. The non-volatile computer storage medium according to claim 10, wherein in the acquiring information of resources provided by the tested application as the information of all the detection objects, the electronic device is caused to:
grasp the information of the resources provided by the tested application, from a user interface that displays the information of the resources provided by the tested application, as the information of all the detection objects.

12. The non-volatile computer storage medium according to claim 7, wherein in the determining a at least one to-be-detected object according to the information of the detection object that has been detected and the information of all the detection objects and separately performing resource embezzlement detection on the at least one to-be-detected object, the electronic device is caused to:
simulatively click an interactive item for viewing or downloading of a designated resource corresponding to information of any detection object other than the information of the detection object that has been detected, on the user interface, so as to enable the tested application to request for the designated resource through a network;
intercept a response message, returned from the network, with respect to the request for the designated resource and extract information of a download address of the designated resource from the response message; and
if the information of the download address comprises predetermined information of a content provider, recording information of the tested application and the designated resource.

13. The non-volatile computer storage medium according to claim 9, wherein the electronic device is further caused to:
separately record the operation object, the information of the simulation operation performed on the operation object, and the simulation operation sequence and separately record a at least one to-be-detected object that has been detected; and
if no fault occurs in the detection task, delete the operation object, the information of the simulation operation performed on the operation object, the simulation operation sequence, and information of the at least one to-be-detected object that has been detected.

14. The electronic device according to claim 8, wherein the running record further records an operation object, information of a simulation operation performed on the operation object, and a simulation operation sequence, wherein the operation object is an interactive item that needs to be operated to acquire the information of all the detection objects; and
the at least one processor is further caused to:
sequentially perform a corresponding simulation operation on a corresponding operation object according to the operation object, the information of the simulation operation performed on the operation object, and the simulation operation sequence.

15. The electronic device according to claim 14, wherein in the sequentially performing a corresponding simulation operation on a corresponding operation object according to the operation object, the information of the simulation operation performed on the operation object, and the simulation operation sequence, the at least one processor is further caused to:
start a tested application; and
acquire information of resources provided by the tested application as the information of all the detection objects.

16. The electronic device according to claim 15, wherein in the acquiring information of resources provided by the tested application as the information of all the detection objects, the at least one processor is further caused to:
grasp the information of the resources provided by the tested application, from a user interface that displays the information of the resources provided by the tested application, as the information of all the detection objects.

17. The electronic device according to claim 8, wherein in the determining a at least one to-be-detected object according to the information of the detection object that has been detected and the information of all the detection objects and separately performing resource embezzlement detection on the at least one to-be-detected object, the at least one processor is further caused to:
simulatively click an interactive item for viewing or downloading a designated resource corresponding to information of any detection object other than the information of the detection object that has been detected, on the user interface, so as to enable the tested application to request for the designated resource through a network;
intercept a response message, returned from the network, with respect to the request for the designated resource and extract information of a download address of the designated resource from the response message; and
if the information of the download address comprises predetermined information of a content provider, record information of the tested application and the designated resource.

18. The electronic device according to claim 14, wherein the at least one processor is further caused to:
separately record the operation object, the information of the simulation operation performed on the operation object, and the simulation operation sequence and separately record a at least one to-be-detected object that has been detected; and
if no fault occurs in the detection task, deleting the operation object, the information of the simulation operation performed on the operation object, the simulation operation sequence, and information of the at least one to-be-detected object that has been detected.
